(19) United States
(12) Patent Application Publication
(10) Pub. No.: US 2011/0281121 A1
(43) Pub. Date: Nov. 17, 2011

(54) Surface Treatment and Article

(76) Inventors: Mingqian He, Horseheads, NY (US); Michael Lesley Sorensen, Waverly, NY (US); Lu Zhang, Painted Post, NY (US)

(21) Appl. No.: 12/781,330

(22) Filed: May 17, 2010

(51) Int. Cl. B32B 17/06; B05D 5/00

(52) U.S. Cl. 428/429; 427/399

(57) ABSTRACT

Surfaces having hydrophobic/oleophobic properties and methods of making them. The surfaces disclosed may be used, for example, in touch screen applications or other applications that involve contact with human skin.

### FIELD OF THE DISCLOSURE

The disclosure relates to surfaces having hydrophobic/oleophobic properties and methods of making them. The surfaces disclosed may be used, for example, in touch screen applications or other applications that involve contact with human skin.

### BACKGROUND

When skin comes in contact with glass, not treated to be smudge resistant it leaves an oily residue that is difficult to remove. By treating the glass, one can increase both the hydrophobicity and oleophobicity of the surface allowing for smudge resistance and easier cleaning of the glass.

Current methods of treating glass to increase hydrophobicity and oleophobicity of the surface involve treating glass with a perfluoropolyetherfunctional trimethoxysilane that requires the use of an expensive fluorinated solvent. The problems associated with this method center on cost of materials, film quality (i.e. uniformity, robustness, and pin-hole formation) and processability of the film and time of cure.

There remains a need for an easily applied coating that provides a water contact angle between 100°-120° and an oleic acid contact angle ranging from 70°-90° and that also provides the desired quality and abrasion resistance.

### SUMMARY

The inventors have now developed a surface treatment by which less expensive materials can be used to accomplish the target contact angles and abrasion resistance in less time compared to conventional techniques.

One embodiment is a method comprising providing a surface comprising surface hydroxyl groups; applying an amine to the surface to form a first coated surface; applying a fluorinated silane compound to the first coated surface to form a second coated surface; and reacting the silane with the amine and surface hydroxyl groups to form a crosslinked network between the amine, fluorinated silane and surface.

An additional embodiment is an article comprising a substrate and a layer chemically bonded to the substrate comprising a fluorinated silane crosslinked with an amine.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a graph comparing contact angle measurements for three embodiments.

FIG. 2 is a graph comparing contact angle measurements as a function of test cycles for two embodiments.

FIG. 3 is a graph comparing contact angle measurements before and after 85/85 temperature/humidity testing.

### DETAILED DESCRIPTION

A first embodiment is a method comprising providing a surface comprising surface hydroxyl groups; applying an amine to the surface to form a first coated surface; applying a fluorinated silane compound to the first coated surface to form a second coated surface; and reacting the silane with the amine and surface hydroxyl groups to form a crosslinked network between the amine, fluorinated silane and surface.

In one embodiment, the provided surface is glass. The provided surface may be present as a layer on a substrate, for example, the provided surface may be a glass layer on a substrate. In another embodiment, the provided surface is a glass substrate. In yet another embodiment, the provided surface is a polymer, either alone or as a layer on a substrate.

The provided surface comprises surface hydroxyl groups. As used herein, the term hydroxyl group refers to the functional group (—OH). In some embodiments, the surface hydroxyl group may be present in the form of a silanol, where the hydroxyl group is bonded to a silicon atom. The number of surface hydroxyl groups on the provided surface may be increased, for example, by plasma cleaning the surface.

In one embodiment, the amine and the fluorinated silane compound are applied in a two-step process. First, the amine is applied to the provided surface to form a first coated surface, followed by applying the fluorinated silane compound to the first coated surface to form a second coated surface. The amine may be applied to the provided surface using any suitable technique, such as, dip coating or aerosol coating. In one embodiment, dip coating may comprise dipping the surface in an amine for a period of 10 seconds, 1 minute, 2 minutes or more. In one embodiment, the amine alone may be applied to the provided surface. In other embodiments, the amine may be dispersed in a solvent then applied to the provided surface.

The fluorinated silane compound may be applied to the first coated surface using any suitable technique, such as, dip coating or aerosol coating. In one embodiment, dip coating may comprise dipping the surface in a fluorinated silane compound for a period of 10 seconds, 1 minute, 2 minutes or more. In one embodiment, the fluorinated silane compound alone may be applied to the first coated surface. In other embodiments, the fluorinated silane compound may be dispersed in a solvent then applied to the first coated surface.

Appropriate solvents include those that are anhydrous, hydrophobic, slow to evaporate and non-reactive with the amine or fluorinated silane compound. Example solvents include aliphatic hydrocarbons such as hexanes, cyclohexane, heptane; substituted aliphatic hydrocarbons such as ethyl lactate; and aromatic hydrocarbons such as toluene.

In one embodiment, the amine functions as a catalyst, promoting the reaction between the fluorinated silane compound and the surface hydroxyl groups. In another embodiment, the amine functions as a crosslinker to form a network between the silicon of the silane, the nitrogen of the amine and the oxygen of the surface hydroxyl groups. In some embodiments, the amine may function as both a catalyst and a crosslinker.

In one embodiment, the amine is multifunctional. As used herein, a multifunctional amine is defined as an amine compound having more than one amine group, for example, a diamine or a triamine.

In one embodiment, the amine comprises a primary or secondary amine, for example, an amine comprising one or two R groups attached to the nitrogen atom. The amine may also comprise at least two primary or at least two secondary amine groups. In one embodiment, the amine is a polyetheramine. Suitable amines include polyetheramines, for example, Jeffamine® Diamines D-230 and D-400; Jeffamine® Triamine T-403; and Jeffamine® EDR-148 and EDR-176. In one embodiment, the amine is selected from tetraethylenetetramine (TETA) and tetraethylenepentamine (TEPA). In one embodiment, the amine is ethylene diamine.

The fluorinated silane compound may be chosen to tailor the final properties of the treated surface. As used herein the term “fluorinated silane” refers to chlorosilanes containing as least one perfluorinated, or partially fluorinated, aliphatic or aromatic substituent. In one embodiment, the silane is a fluorinated alkyl silane. Suitable silanes include perfluoralkyltrichlorosilanes, for example, perfluorooctyltrichlorosilane, and fluorinated alkylsilanes such as (heptadecafluoro-1,1,2,2-tetrahydrodecyl)trichlorosilane. The solubility of the silane in the solvent can be considered when choosing the most appropriate combinations of silanes and solvents. In this respect, the solubility of the silane in standard hydrocarbon solvents decreases as the degree of fluorination increases.

The reactions involving the silane with the amine and hydroxyl groups may occur spontaneously. In one embodiment, the reaction may be driven to completion via heating, for example, in an oven. The treated surface may be heated for example at 100 degrees C. for 10 minutes, 20 minutes, or more. Heating may also be employed to evaporate any excess solvent remaining on the surface.

Some embodiments include a drying step between and/or after amine and/or silane applications. Depending on the solvent, the first coated surface may be air dried for a period of time, such as 1 minute, 5 minutes, 10 minutes or more before the fluorinated silane compound is applied. Furthermore, the second coated surface may be air dried for a period of time, such as 1 minute, 5 minutes, 10 minutes or more before heating.

In one embodiment, the crosslinked network formed between the amine, fluorinated silane and surface includes silicon of at least a portion of the silane bonded to the nitrogen of at least a portion of the amine and at least a portion of oxygen of the surface hydroxyl groups. In one embodiment, the crosslinked network forms a hydrophobic coating on the provided surface. Hydrophobic surfaces include those surfaces that are antagonistic to water, mostly incapable of dissolving in water in an appreciable amount or being repelled from water or not being wetted by water.

In one embodiment, the crosslinked network forms an oleophobic coating on the provided surface. Oleophobic surfaces include those surfaces that lack an affinity to oils.

A second embodiment is an article comprising a substrate; and a layer chemically bonded to the substrate comprising a fluorinated silane crosslinked with an amine.

In one embodiment, the substrate is glass. In another embodiment, the substrate is a polymer.

In one embodiment, the layer comprising a fluorinated silane crosslinked with an amine includes silicon of the silane bonded to nitrogen of the amine. The layer is chemically bonded to the substrate via bonds between the silicon of the silane and oxygen of the surface hydroxyl groups.

In one embodiment, the layer is a hydrophobic surface, for example, the surface has a water contact angle greater than 95 degrees, such as, greater than 98 degrees, greater than 100 degrees, or greater than 105 degrees. In one embodiment, the surface is oleophobic, for example, the surface has an oleic acid contact angle greater than 70 degrees.

Various embodiments will be further clarified by the following examples.

Glass substrates were cleaned in an ultrasonic bath containing a 4% soap solution. After ultrasonic cleaning, the glass substrates were rinsed twice in DI water to remove any soap residue. The glass substrates were placed in a plasma cleaner and air plasma cleaned for 10 minutes to remove any residual organic material from the surface and form silanol groups on the surface.

Two separate solutions were prepared for coating the glass substrates. First, an amine solution comprising 0.15 ml of ethylene diamine (EDA) suspended in 150 ml of hexanes. Second, a fluorinated silane compound solution comprising 0.2 ml of (Heptadecafluoro-1,1,2,2-tetrahydrodecyl)trichlorosilane (HDFTCS) in 150 ml of hexanes.

The air plasma treated glass substrates were first placed into the amine/hexanes solution for 1 minute. After 1 minute, the glass substrates were removed and allowed to air dry. Once visibly dry the amine coated glass substrates were placed in the silane/hexanes solution for 1 minute. After 1 minute, the substrates were air dried, placed in a holder, and placed in a 100° C. oven for one hour. After the one hour post bake, the substrates were rinsed with water followed by a rinse with ethanol and blown dry with a stream of nitrogen.

Three glass substrates were prepared using the method described above. Sample A was not treated with an amine catalyst/crosslinker prior to silane coating. Sample B was treated with EDA prior to silane coating and Sample C was treated with triamine functional polyetheramine (TA) prior to silane coating. All three samples were treated with HDFTCS.

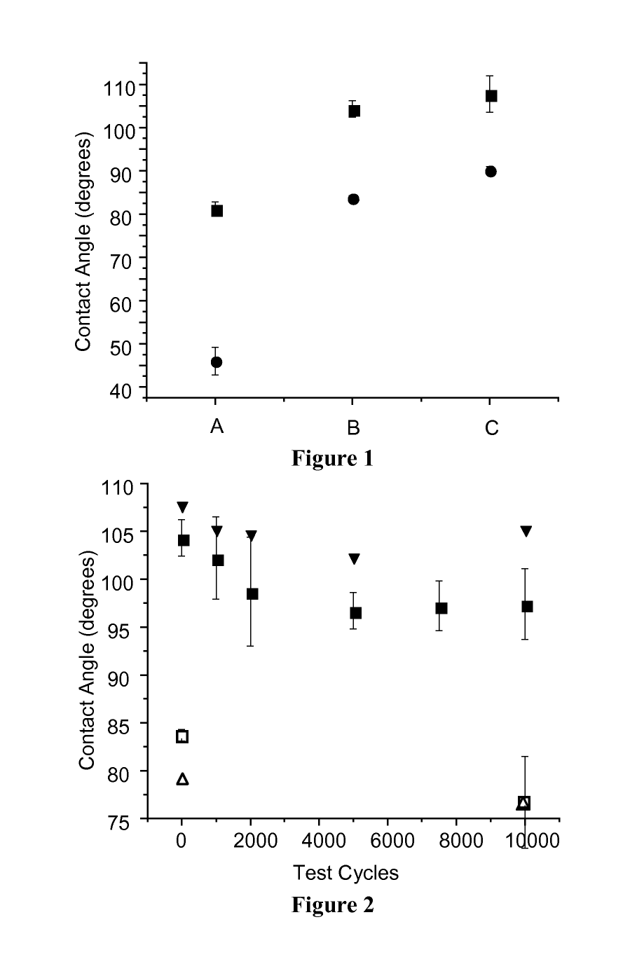

Contact angle measurements for water (represented as squares) and oleic acid (represented as circles) are shown for the three samples in FIG. 1.

The results of an abrasion resistance test of samples B and C are shown in FIG. 2, which graphs the contact angle as a function of test cycles. A test cycle is defined as a forward and reverse wipe of the sample surface; the contact angle is measured at various points throughout the process up to 10,000 test cycles. Water contact angle for sample B is represented as a solid square and oleic acid contact angle for sample B is represented as an open square. Water contact angle for sample C is represented as a solid triangle and oleic acid contact angle for sample C is represented as an open triangle.

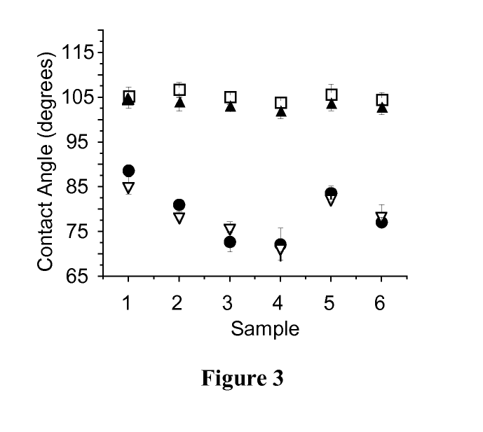

Additional glass samples were prepared as above using trifunctional polyetheramine in toluene (2 minutes) and fluorosilane in hexanes (1 minute). Samples were collected from each step of the process and tested in 85/85 temperature/humidity conditions for 672 hours. Samples were as follows: 1) control, 2) ethanol rinse step between amine and silane dips, 3) ethanol rinse step after silane dip, 4) ethanol rinse after amine and silane steps, 5) 15 min bake at 100° C. after amine step, and 6) ethanol rinse and 15 min bake at 100° C. after amine step. FIG. 3 compares the contact angle measurements for water before, represented by open squares, and after testing, represented by solid triangles. Also shown in FIG. 3 are contact angle measurements for oil before, represented by solid circles, and after testing, represented by open triangles.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. A method comprising:
providing a surface comprising surface hydroxyl groups;
applying an amine to the surface to form a first coated surface;
applying a fluorinated silane compound to the first coated surface to form a second coated surface; and
reacting the silane with the amine and surface hydroxyl groups to form a crosslinked network between the amine, fluorinated silane and surface.

2. A method of claim 1, wherein the provided surface is plasma cleaned.

3. A method of claim 1, wherein the provided surface is glass.

4. A method of claim 1, wherein the provided surface is a polymer.

5. A method of claim 1, wherein the amine is multifunctional.

6. A method of claim 5, wherein the amine comprises a primary or secondary amine.

7. A method of claim 1, wherein the amine is a polyetheramine.

8. A method of claim 1, wherein the amine is selected from ethylene diamine and triamine functional polyetheramine.

9. A method of claim 1, wherein the silane is a fluorinated alkyl silane.

10. A method of claim 1, wherein the silane is (heptadecafluoro-1,1,2,2-tetrahydrodecyl)trichlorosilane.

11. A method of claim 1, wherein the amine is applied via dip coating.

12. A method of claim 1, wherein the amine is applied via aerosol coating.

13. A method of claim 1, wherein the fluorinated silane is applied via dip coating.

14. A method of claim 1, wherein the fluorinated silane is applied via aerosol coating.

15. A method of claim 1, wherein the crosslinked network forms a hydrophobic coating on the provided surface.

16. A method of claim 1, wherein the crosslinked network forms an oleophobic coating on the provided surface.

17. An article comprising:
a substrate; and
a layer chemically bonded to the substrate comprising a fluorinated silane crosslinked with an amine.

18. An article of claim 17, wherein the layer is a hydrophobic surface.

19. An article of claim 17, wherein the surface has a water contact angle greater than 95 degrees.

20. An article of claim 17, wherein the surface has an oleic acid contact angle greater than 70 degrees.
